(19) United States
(12) Patent Application Publication
(10) Pub. No.: US 2023/0033222 A1
(43) Pub. Date: Feb. 2, 2023

(54) INTEGRATED BLENDER AND FRICTION REDUCER SYSTEM

(71) Applicant: STEWART & STEVENSON LLC, Houston, TX (US)

(72) Inventors: Brian Sharp, Houston, TX (US); Paul Smith, Houston, TX (US); Eric Evezic, Houston, TX (US); Jeff Smith, Houston, TX (US)

(21) Appl. No.: 17/387,291

(22) Filed: Jul. 28, 2021

(51) Int. Cl. B01F 13/00; B01F 3/12; B01F 15/02; B01F 7/00; B01F 15/00

(52) U.S. Cl. CPC B01F 13/004; B01F 3/1221; B01F 15/0235; B01F 15/0243; B01F 15/0259; B01F 7/0025; B01F 15/00149; B01F 15/0251; B01F 15/0283; B01F 2215/0081; B01F 2003/1257; E21B 43/2607

(57) ABSTRACT

An integrated blender system includes a skid. The integrated blender system includes a blender assembly, including a blender tub including an outlet, a supply pipe coupled between a suction pump and the blender tub, and an outlet pipe coupled to the outlet of the blender tub. The integrated blender assembly includes a dry product additive system. The dry product additive system includes a skid, a hopper, a pickup funnel, a feeder system, a supply pump, and an eductor assembly. The feeder system may be configured to transport product from the hopper to the pickup funnel. The eductor assembly including a suction inlet, a motive inlet, and an outlet. The suction inlet may be coupled to the pickup funnel by a suction hose. The motive inlet may be coupled to the supply pump by a motive fluid hose. The outlet nozzle is positioned to eject fluid and product into the blender tub.

### TECHNICAL FIELD/FIELD OF THE DISCLOSURE

The present disclosure relates generally to well service equipment and specifically to equipment used with well fluids.

### BACKGROUND OF THE DISCLOSURE

During drilling, completion, and production operations, fluids are circulated through a wellbore. Various chemicals are introduced into the fluids, referred to herein as the slurry, to produce slurry having desirable characteristics. In some cases, chemicals may be provided in dry form.

### SUMMARY

An integrated blender system may include a skid. The integrated blender system may include a blender assembly. The integrated blender assembly may include a blender tub including an outlet, a supply pipe coupled between a suction pump and the blender tub, and an outlet pipe coupled to the outlet of the blender tub. The integrated blender system may include a dry product additive system. The dry product additive system may include a hopper. The dry product additive system may include a pickup funnel. The dry product additive system may include a feeder system configured to transport product from the hopper to the pickup funnel. The dry product additive system may include a supply pump. The dry product additive system may include an eductor assembly, the eductor assembly including a suction inlet, a motive inlet, and an outlet. The suction inlet may be coupled to the pickup funnel by a suction hose. The motive inlet may be coupled to the supply pump by a motive fluid hose. The outlet nozzle may be positioned to eject fluid and product into the blender tub.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a side view of an integrated blender system consistent with at least one embodiment of the present disclosure.

FIG. 2 depicts a perspective view of the integrated blender system of FIG. 1.

FIG. 3 depicts a partial top view of the integrated blender system of FIG. 1.

FIG. 4 depicts a schematic of an integrated blender system consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

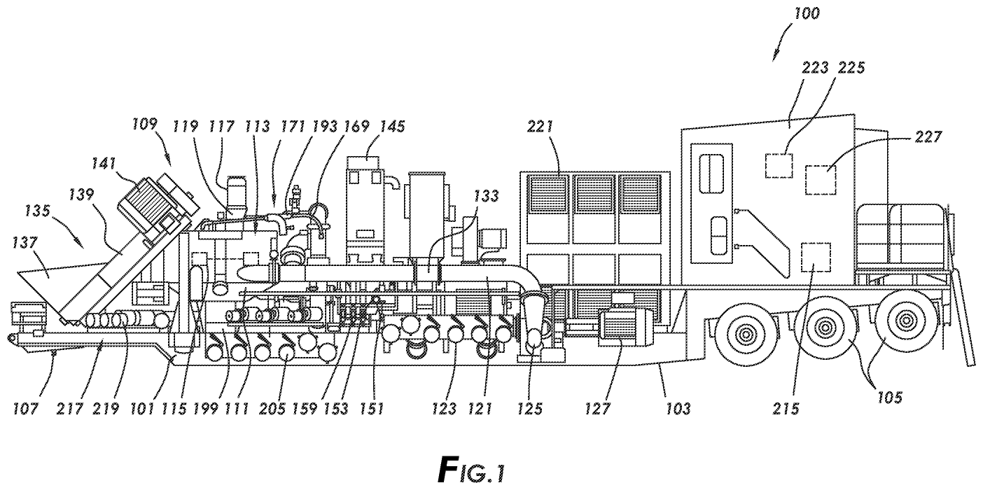

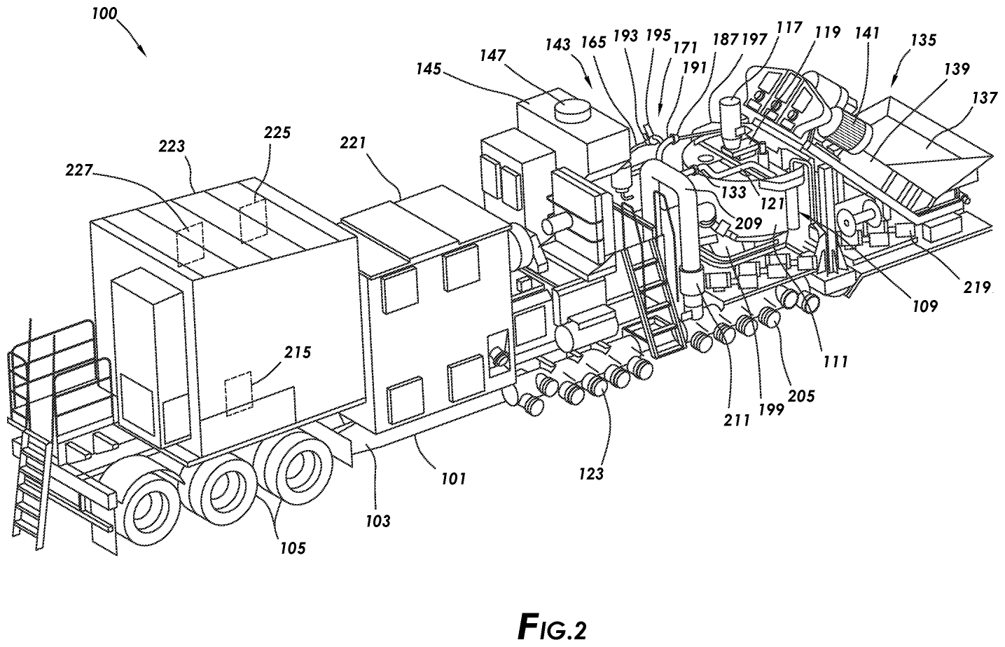

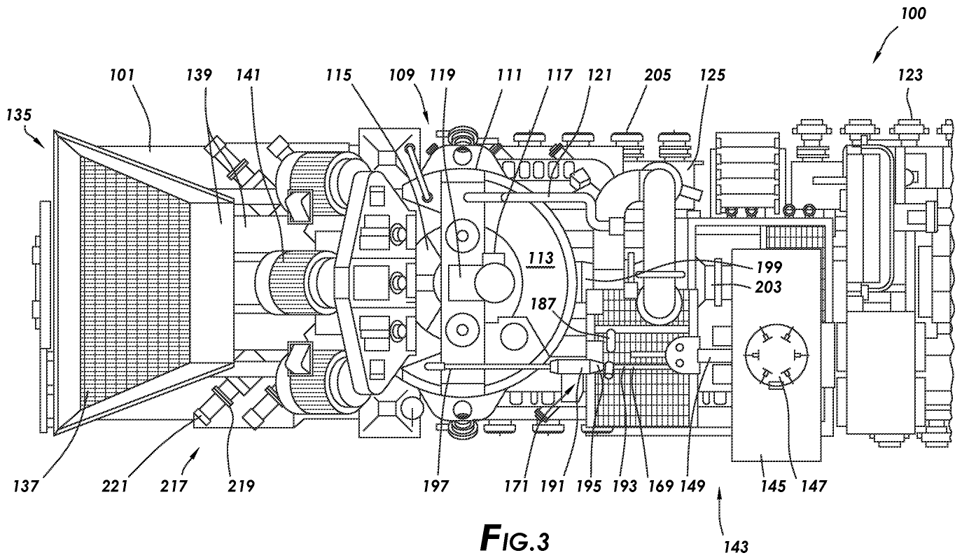

FIGS. 1-4 depict integrated blender system 100. Integrated blender system 100 may be used to prepare fluids for use in wellbore operations including stimulation operations such as hydraulic fracturing operation. For the purposes of this disclosure and without any intent to limit the scope of this disclosure, the fluids prepared by integrated blender system 100 are referred to herein as a slurry made up of ingredients, chemicals, products, and base fluids as understood in the art such as, for example and without limitation, friction reducer, high viscosity friction reducer, guar or synthetic gel, inhibitors, PH buffers, and biocides.

In some embodiments, integrated blender system 100 may include skid 101. Skid 101 may support components of integrated blender system 100 and may provide for transportation of integrated blender system 100 while allowing all components thereof to remain operatively coupled. In some embodiments, skid 101 may be positioned on or may be part of trailer 103 that includes one or more wheels 105 and hitch assembly 107 positioned to allow integrated blender system 100 to be transported by towing. In some such embodiments, trailer 103 may be a rockover trailer.

Integrated blender system 100 may include blender assembly 109. Blender assembly 109 may be adapted to mix one or more ingredients, chemicals, and products with a base fluid to generate a slurry used, for example and without limitation, in a wellbore stimulation operation such as a hydraulic fracturing operation. Blender assembly 109 may include blender tub 111, which defines mixing chamber 113. Blender tub 111 may be a vessel into which ingredients, chemicals, products, and base fluids may be introduced and mixed. In some embodiments, blender assembly 109 may include one or more blender paddles 115 positioned within mixing chamber 113 and rotatably driven by tub paddle motor 117. In some embodiments, tub paddle motor 117 may be an electric motor. In some embodiments, tub paddle motor 117 may operatively couple to blender paddles 115 via paddle gearbox 119. Blender paddles 115 may, as they rotate within mixing chamber 113, agitate and mix the ingredients, chemicals, products, and base fluids introduced thereinto to prepare the slurry.

In some embodiments, base fluids may be introduced into blender tub 111 via supply pipe 121 coupled thereto. In some embodiments, supply pipe 121 may be fluidly coupled to suction manifold 123 via suction pump 125. Suction pump 125 may be driven by suction pump motor 127. In some embodiments, suction pump motor 127 may be an electric motor. In some embodiments, suction pump 125 may be used to draw fluids such as base fluids from external tanks or reservoirs through suction manifold 123 and pump the fluids into mixing chamber 113 through supply pipe 121. In some embodiments, flow meter 133 may be positioned on supply pipe 121 to, for example and without limitation, measure the amount of fluid provided to mixing chamber 113 by suction pump 125.

In some embodiments, integrated blender system 100 may include proppant feed system 135. Proppant feed system 135 may be positioned on skid 101. Proppant feed system 135 may include proppant hopper 137. Proppant hopper 137 may be positioned at an end of skid 101 and may be positioned such that proppant, sand, or other product may be added thereto for introduction into mixing chamber 113. In some embodiments, proppant feed system 135 may include one or more augers 139. Augers 139 may be connected to the bottom of proppant hopper 137 and may extend to a position above blender tub 111. Augers 139 be used to lift product within proppant hopper 137 and deposit the product into mixing chamber 113 of blender tub 111 by rotating augers 139. In some embodiments, each auger 139 may be powered by a corresponding auger motor 141. In some embodiments, auger motors 141 may be electric motors.

In some embodiments, integrated blender system 100 may include dry product additive system 143. Dry product additive system 143 may be positioned on skid 101. In some embodiments, dry product additive system 143 may include hopper 145. Hopper 145 may be used to store dry chemicals, referred to herein as product, for use in a well operation. For example, in some embodiments, hopper 145 may be used to store guar gel, friction reducer, or high-viscosity friction reducer. In some embodiments, hopper 145 may be Tillable during operation of dry product additive system 143. In such embodiments, hopper 145 may remain at atmospheric pressure during operation of dry product additive system 143. In some embodiments, hopper 145 may include upper hatch 147 positioned at an upper surface of hopper 145 to allow product to be added to hopper 145. In some embodiments, dry product additive system 143 may include hopper fill tube 149. Hopper fill tube 149 may be coupled to hopper 145 and may allow for product to be added to hopper 145 without opening upper hatch 147.

In some embodiments, hopper 145 may be supported by hopper support struts 151 coupled to skid 101. In some embodiments, one or more load cells 153 may be positioned between hopper 145 and hopper support struts 151 to, for example and without limitation, measure the weight of hopper 145 and thereby monitor the amount of product within hopper 145 during use.

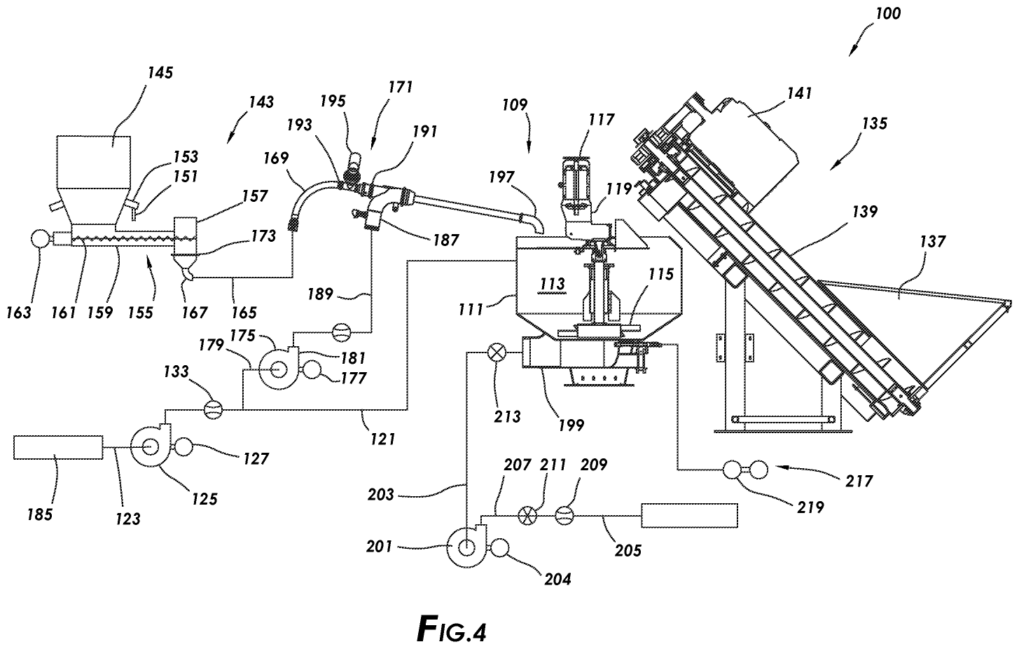

In some embodiments, as shown in FIG. 4, dry product additive system 143 may include feeder system 155. Feeder system 155 may be positioned beneath hopper 145 and may be used to deliver product from within hopper 145 to pickup funnel 157. Feeder system 155 may include trough 159 positioned beneath hopper 145 and positioned to receive product from hopper 145 by gravity feed. In some embodiments, feeder system 155 may include feed auger 161 positioned within trough 159 such that rotation of feed auger 161 moves product through trough 159 and into pickup funnel 157. In some embodiments, feed auger 161 may be driven by feeder motor 163, which may be an electric motor.

In some embodiments, pickup funnel 157 may be coupled to suction hose 165, which may couple between output flange 167 of pickup funnel 157 and suction inlet 169 of eductor assembly 171. As discussed below, eductor assembly 171 may provide suction force to move the product within pickup funnel 157 through suction hose 165 and into eductor assembly 171. In some such embodiments, pickup funnel 157 may include vents 173 positioned to allow air to enter pickup funnel 157 as product is removed from pickup funnel 157.

In some embodiments, dry product additive system 143 may include supply pump 175. Supply pump 175 may, in some embodiments, be a centrifugal pump driven by pump motor 177, which may be an electric motor. In other embodiments, supply pump 175 may be, for example and without limitation, a gear pump, rotary vane pump, lobe pump, piston pump, diaphragm pump, screw pump, peristaltic pump, or axial flow pump. Supply pump 175 may receive a fluid through pump inlet 179 and output the fluid through pump outlet 181. In some embodiments, the fluid, referred to herein as the motive fluid, may be water as supplied by water supply 185. Water supply 185 may be positioned on skid 101 or may be positioned apart from skid 101. Water supply 185 may be a tank or other reservoir. Although described as a water supply, any liquid may be used as described herein. In some embodiments, pump outlet 181 may be coupled to motive inlet 187 of eductor assembly 171 by motive fluid hose 189.

When supply pump 175 is engaged, motive fluid is pumped through motive fluid hose 189 into motive inlet 187 of eductor assembly 171. Eductor assembly 171 may include eductor 191. Eductor 191 may be a venturi that, without being bound to theory, produces suction or sub-ambient pressure at suction inlet 193 due to the high-speed motion of the motive fluid when the motive fluid is pumped into eductor 191. The suction at suction inlet 169 may draw product into eductor 191 through suction hose 165 from pickup funnel 157.

In some embodiments, dry product additive system 143 may include vacuum breaker valve 195. Vacuum breaker valve 195 may be positioned on eductor assembly 171 such that vacuum breaker valve 195 is fluidly coupled to suction inlet 169 before eductor 191. Vacuum breaker valve 195 may be used to allow sufficient pressure in motive fluid hose 189 and eductor assembly 171 to be built up during startup of supply pump 175. If such pressure is not adequately built up, fluid from motive fluid hose 189 may backfeed through eductor assembly 171 and into other components of dry product additive system such as hopper 145 via suction hose 165. During startup of supply pump 175, vacuum breaker valve 195 may be opened, allowing air to enter eductor assembly 171 and reducing or preventing suction forces to act on suction hose 165. Once sufficient pressure is reached in motive fluid hose 189, vacuum breaker valve 195 may be closed, allowing the suction force generated by eductor assembly 171 to act on suction hose 165 and draw the product within pickup funnel 157 into eductor assembly 171. Similarly, during shutdown of dry product additive system 143, vacuum breaker valve 195 may be opened to reduce or remove suction force on suction hose 165, thereby reducing or stopping the flow of product into eductor assembly 171 and also preventing or reducing the incidence of backflow of motive fluid through suction hose 165.

In some embodiments, eductor 191 may introduce product into the stream of motive fluid as both the product and motive fluid pass through eductor 191 or other components of eductor assembly 171 such as outlet nozzle 197. Outlet nozzle 197 may be positioned to eject the combination of motive fluid and product into mixing chamber 113 of blender tub 111.

In some embodiments, blender tub 111 may include outlet 199 positioned at the base of blender tub 111. Outlet may be fluidly coupled to discharge pump 201 by outlet pipe 203. Discharge pump 201 may be driven by discharge pump motor 204. In some embodiments, discharge pump motor 204 may be an electric motor. Discharge pump 201 may be fluidly coupled to discharge manifold 205. Discharge pump 201 may be operated to pump slurry from blender tub 111 to discharge manifold 205 by discharge pipe 207, from which slurry may be piped to other wellsite equipment for use in a wellbore. In some embodiments, outlet pipe 203 or discharge pipe 207 may include discharge flow meter 209 and discharge densitometer 211 positioned to measure the flow rate and density, respectively, of slurry pumped through discharge pump 201. In some embodiments, outlet pipe 203 or discharge pipe 207 may include valve 213 positioned to allow or prevent flow of slurry from blender tub 111. In some embodiments, valve 213 may be pneumatically, hydraulically, or electrically actuated.

In some embodiments, integrated blender system 100 may include air compressor 215. Air compressor 215 may be positioned on skid 101. Air compressor 215 may be used, for example and without limitation, to actuate components of integrated blender system 100 including valve 213. Air compressor 215 may be electrically driven.

In some embodiments, integrated blender system 100 may include liquid chemical additive system 217. Liquid chemical additive system 217 may include one or more liquid chemical pumps 219 which may be used to introduce liquid chemicals to mixing chamber 113 of blender tub 111. Liquid chemical pumps 219 may be electrically driven.

In some embodiments, integrated blender system 100 may include transformer 221. Transformer 221 may be positioned on skid 101 and may be used to transform incoming electric power to an appropriate voltage usable by systems of integrated blender system 100.

In some embodiments, integrated blender system 100 may include enclosure 223. In some embodiments, enclosure 223 may house one or more electric components of integrated blender system 100 including, for example and without limitation, circuit protection equipment 225 and variable frequency drive (VFD) 227. Circuit protection equipment 225 may include one or more of fuses, circuit breakers, shunts, switching gear, and other components used to protect electric components of integrated blender system 100.

In some embodiments, VFD 227 may be used to operate one or more electric motors of integrated blender system 100 including, for example and without limitation, tub paddle motor 117, suction pump motor 127, auger motors 141, feeder motor 163, pump motor 177, discharge pump motor 204, air compressor 215, and liquid chemical pumps 219. Although described as a single VFD, VFD 227 may be multiple VFDs used to power one or more of tub paddle motor 117, suction pump motor 127, auger motors 141, feeder motor 163, pump motor 177, discharge pump motor 204, air compressor 215, and liquid chemical pumps 219 individually. VFD 227 may allow for selective actuation of and individual speed control of each of tub paddle motor 117, suction pump motor 127, auger motors 141, feeder motor 163, pump motor 177, discharge pump motor 204, air compressor 215, and liquid chemical pumps 219.

In some embodiments, integrated blender system 100 may be operated remotely.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. An integrated blender system comprising:
a skid;
a blender assembly, the blender assembly including:
a blender tub, the blender tub including an outlet;
a supply pipe, the supply pipe coupled between a suction pump and the blender tub;
an outlet pipe coupled to the outlet of the blender tub; and
a dry product additive system including:
a hopper;
a pickup funnel;
a feeder system, the feeder system configured to transport product from the hopper to the pickup funnel;
a supply pump; and
an eductor assembly, the eductor assembly including a suction inlet, a motive inlet, and an outlet nozzle, the suction inlet coupled to the pickup funnel by a suction hose, the motive inlet coupled to the supply pump by a motive fluid hose, the outlet nozzle positioned to eject fluid and product into the blender tub.

2. The integrated blender system of claim 1, further comprising one or more blender paddles positioned within the blender tub, the blender paddles driven by a tub paddle motor.

3. The integrated blender system of claim 2, wherein the tub paddle motor is coupled to the blender paddles by a paddle gearbox.

4. The integrated blender system of claim 1, wherein the suction pump is positioned to draw fluid from a suction manifold.

5. The integrated blender system of claim 1, further comprising a flow meter positioned on the supply pipe.

6. The integrated blender system of claim 1, further comprising a proppant adding system.

7. The integrated blender system of claim 6, wherein the proppant adding system comprises:
a proppant hopper;
an auger connected to the bottom of the proppant hopper and extending to a position above the blender tub; and
an auger motor positioned to drive the auger.

8. The integrated blender system of claim 1, wherein the hopper further comprises an upper hatch.

9. The integrated blender system of claim 1, further comprising a hopper fill tube, the hopper fill tube coupled to the hopper.

10. The integrated blender system of claim 1, wherein the feeder system comprises a trough, the trough positioned below the hopper such that product positioned within the hopper is gravity fed into the trough, the trough coupled to the pickup funnel.

11. The integrated blender system of claim 10, wherein the feeder system comprises a feed auger, the feed auger positioned within the trough.

12. The integrated blender system of claim 11, wherein the feed auger is driven by a feeder motor.

13. The integrated blender system of claim 1, wherein the pickup funnel comprises a vent.

14. The integrated blender system of claim 1, further comprising a load cell positioned between the hopper and the skid.

15. The integrated blender system of claim 1, wherein the supply pump is a centrifugal pump.

16. The integrated blender system of claim 1, wherein the supply pump is driven by a pump motor.

17. The integrated blender system of claim 1, further comprising a vacuum breaker valve positioned on the eductor assembly fluidly coupled to the suction inlet.

18. The integrated blender system of claim 1, further comprising, a discharge pump coupled to the outlet by an outlet pipe.

19. The integrated blender system of claim 18, wherein the discharge pump is coupled to a discharge manifold by a discharge pipe.

20. The integrated blender system of claim 19, wherein the outlet pipe or the discharge pipe further comprises a flow meter or discharge densitometer.

21. The integrated blender system of claim 19, wherein the outlet pipe or the discharge pipe comprises a valve.

22. The integrated blender system of claim 1, further comprising an air compressor.

23. The integrated blender system of claim 1, wherein the skid is part of a trailer.

24. The integrated blender system of claim 1, further comprising a liquid chemical additive system, the liquid chemical additive system including a liquid chemical pump.

25. The integrated blender system of claim 1, further comprising a transformer positioned on the skid.

26. The integrated blender system of claim 1, further comprising a variable frequency drive positioned on the skid.
